(19) United States
(12) Patent Application Publication
(10) Pub. No.: US 2013/0071642 A1
(43) Pub. Date: Mar. 21, 2013

(54) FABRIC ASSEMBLY SUITABLE FOR RESISTING BALLISTIC OBJECTS AND METHOD OF MANUFACTURE

(71) Applicants: Leopoldo Alejandro Carbajal, Newwark, DE (US); Ronald G. Egres, JR., Midlothian, VA (US)

(72) Inventors: Leopoldo Alejandro Carbajal, Newwark, DE (US); Ronald G. Egres, JR., Midlothian, VA (US)

(73) Assignee: E. I. DU PONT DE NEMOURS AND COMPANY, Wilmington, DE (US)

(21) Appl. No.: 13/418,425

(22) Filed: Mar. 13, 2012

Related U.S. Application Data
(63) Continuation-in-part of application No. 13/169,598, filed on Jun. 27, 2011.
Application No. 13/169,598 is a continuation-in-part of application No. 12/369,227, filed on Feb. 11, 2009, now Pat. No. 7,968,475.
Application No. 12/369,227 is a continuation-in-part of application No. 12/368,539, filed on Feb. 10, 2009, now abandoned.

(51) Int. Cl. B32B 5/06; B32B 37/00; B32B 7/14; B32B 5/02; B32B 7/08

(52) U.S. Cl. CPC B32B 5/06; B32B 5/02; B32B 7/08; B32B 7/14; B32B 37/0084
USPC 428/219; 428/221; 156/291; 29/525.01; 112/475.09; 29/432

(57) ABSTRACT

A fabric assembly particularly useful as soft body armor has two or more separate sections each containing a number of fabrics made from yarns having a tenacity of at least 7.3 grams per dtex and a modulus of at least 100 grams per dtex. At least one of the sections in the fabric assembly is comprised of compressed fabrics attached by connector yarns having a force to break in tension not greater than 65N concentrated along a series of parallel connector lines as viewed from the fabric on both outer surfaces of the first section, the connector lines being spaced from 1.8 mm to 51 mm apart defining regions between the connector lines where the fabric layers remain unconnected.

### RELATED APPLICATION

The present patent application is a continuation-in-part of Ser. No. 13/169,598 filed Jun. 27, 2011 which is a continuation-in-part of Ser. No. 12/369,227 filed Feb. 11, 2009 which in turn is a continuation-in-part of Ser. No. 12/368,539 filed Feb. 10, 2009, now abandoned.

### BACKGROUND OF INVENTION

1. Field of the Invention

This invention relates to a fabric assembly particularly suitable as ballistic resistant soft body armor and method of manufacture.

2. Description of the Related Art

Many designs for body armor for resisting ballistic threats have been proposed and many commercialized. Designs are made to increase comfort by the wearer and/or to add extra penetration resistance without increasing areal density. Comfort is generally increased by making the body armor lighter and more flexible to allow freedom of motion by the wearer. However, reduction in apparel weight should not be achieved at the expense of a significant reduction in anti-ballistic performance.

US 2008/0075933 A1 discloses a ballistic-resistant assembly containing flexible elements of high strength fibers having connecting means on a rear part side of the assembly to interconnect adjacent elements. Such assemblies are claimed to reduce trauma (back face deformation) during a ballistic event.

Niemi and Cuniff in Technical Note Natick/TN-91/0004 with a title “The Performance of Quilted Body Armor Systems Under Ballistic Impact by Right Circular Cylinders” state that “Based on results obtained with 1.1 gram right circular cylinders, the effect of quilting resulted in little or no increase in the calculated ballistic limit values or specific energy absorption capacity of the Kevlar®, Spectra® and nylon armor systems evaluated”.

There is a need for a light weight soft body armor which allows an increase in ballistic resistance without an increase in weight.

### SUMMARY OF THE INVENTION

The present invention is directed to a fabric assembly suitable for resisting a ballistic object comprising:
(a) at least one first section comprising a plurality of connected and compacted fabric layers made from continuous yarn having a tenacity of at least 7.3 grams per dtex and a modulus of at least 100 grams per dtex, wherein

(i) the connected and compacted fabric layers are secured together by connectors having a force to break in tension not greater than 65 N,

(ii) the connectors are concentrated along a series of parallel connector lines as viewed from the fabric on both outer surfaces of the first section, and

(iii) the connector lines do not intersect and are spaced from 1.8 mm to 51 mm apart defining regions between the connector lines where the fabric layers remain unconnected, and
(b) at least one second section comprising a plurality of fabric layers made from continuous yarn having a tenacity of at least 7.3 grams per dtex and a modulus of at least 100 grams per dtex wherein the fabrics of the second section are not secured together by parallel connector lines that are spaced from 1.8 mm to 51 mm apart defining regions between the connector lines where the fabric layers remain unconnected, the connectors having a force to break in tension not greater than 65 N.

The invention further relates to a fabric assembly comprising two or more first sections each first section comprising a plurality of connected and compacted fabric layers made from yarn having a tenacity of at least 7.3 grams per dtex and a modulus of at least 100 grams per dtex wherein

(i) the connected and compacted fabric layers are secured together by connectors having a force to break in tension not greater than 65 N,

(ii) the connectors are concentrated along a series of parallel connector lines as viewed from the fabric on both outer surfaces of the first section, and

(iii) the connector lines do not intersect and are spaced from 1.8 mm to 51 mm apart defining regions between the connector lines where the fabric layers remain unconnected.

The invention also pertains to a method of manufacture of a fabric assembly.

### BRIEF DESCRIPTION OF DRAWINGS

FIG. 1A is a plan view of the outer fabric layers (plies) of a first section and explains connector yarn lines, connector yarn length, connector row spacing and unconnected area.

FIG. 1B is an end view of a staple or clip connector.

FIG. 2 is a plan view of a second section of fabric layers without connector yarns and held together by corner tack stitching.

FIG. 3A is a sectional view of a first section comprising a plurality of fabric layers connected by a chain stitched connector yarn. This is referenced as “A”.

FIG. 3B is a sectional view of a second section comprising a plurality of fabric layers not connected by connector yarn. This is referenced as “B”.

FIG. 3C is a sectional view of a first section comprising a plurality of fabric layers connected by connector yarns forming a lock stitch. This is referenced as “A”.

FIG. 3D is a sectional view of a first section comprising a plurality of fabric layers connected by staples. This is referenced as “A”.

FIG. 4A is a sectional view of a vest stack having a first section per A of FIG. 3A as a strike face and a second section per B of FIG. 3B as a back face.

FIG. 4B is a sectional view of a vest stack assembled from a number of sub-assemblies of fabric layers A at the strike face and a number of sub-assemblies of fabric layers B at the back face.

FIG. 5 is a sectional view of a vest stack having a repeat sequence of A and B.

FIG. 6A is a sectional view of a vest stack having first sections per A of FIG. 3A as a strike face and a back face sandwiching a core having a second section per B of FIG. 3B.

FIG. 6B is a sectional view of a vest stack having second sections per B of FIG. 3B as a strike face and back face sandwiching a core having a first section per A of FIG. 3A.

FIG. 7 is a sectional view of a vest stack comprising two first sections per A of FIG. 3A.

### DETAILED DESCRIPTION

A fabric assembly suitable for resisting a ballistic object comprises at least two separate sections that may be all first sections or a combination of first and second sections. Each section contains a plurality of fabric layers made from yarns having a tenacity of at least 7.3 grams per dtex and a modulus of at least 100 grams per dtex.

As employed herein “plurality” means at least two. However in many instances at least five and sometimes at least ten or up to thirty fabric layers will be employed in the first and/or second sections of the fabric assembly.

### Yarns of the First and Second Sections of the Fabric Assembly

Yarns having a tenacity of at least 7.3 grams per dtex and a modulus of at least 100 grams per dtex are employed in the fabric layers of the first and second sections. Such yarns are well known in the art. It is understood that the yarns and fabric constructions used to fabricate the different sections need not be identical. Suitable materials for the yarn include polyamide, polyolefin, polyazole and mixtures thereof.

When the polymer is polyamide, aramid is preferred. The term “aramid” means a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968.

A preferred aramid is a para-aramid. A preferred para-aramid is poly(p-phenylene terephthalamide) which is called PPD-T. By PPD-T is meant a homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

When the polymer is polyolefin, polyethylene or polypropylene is preferred. The term “polyethylene” means a predominantly linear polyethylene material of preferably more than one million molecular weight that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE) or ultra high molecular weight polyethylene (UHMWPE

In some preferred embodiments polyazoles are polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures.

Preferred polybenzazoles are polybenzimidazoles, polybenzothiazoles, and polybenzoxazoles and more preferably such polymers that can form fibers having yarn tenacities of 30 grams per denier (gpd) or greater. If the polybenzazole is a polybenzothioazole, preferably it is poly(p-phenylene benzobisthiazole). If the polybenzazole is a polybenzoxazole, preferably it is poly(p-phenylene benzobisoxazole) and more preferably poly(p-phenylene-2,6-benzobisoxazole) called PBO.

Preferred polypyridazoles are polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. A preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures.

### First Section of the Fabric Assembly

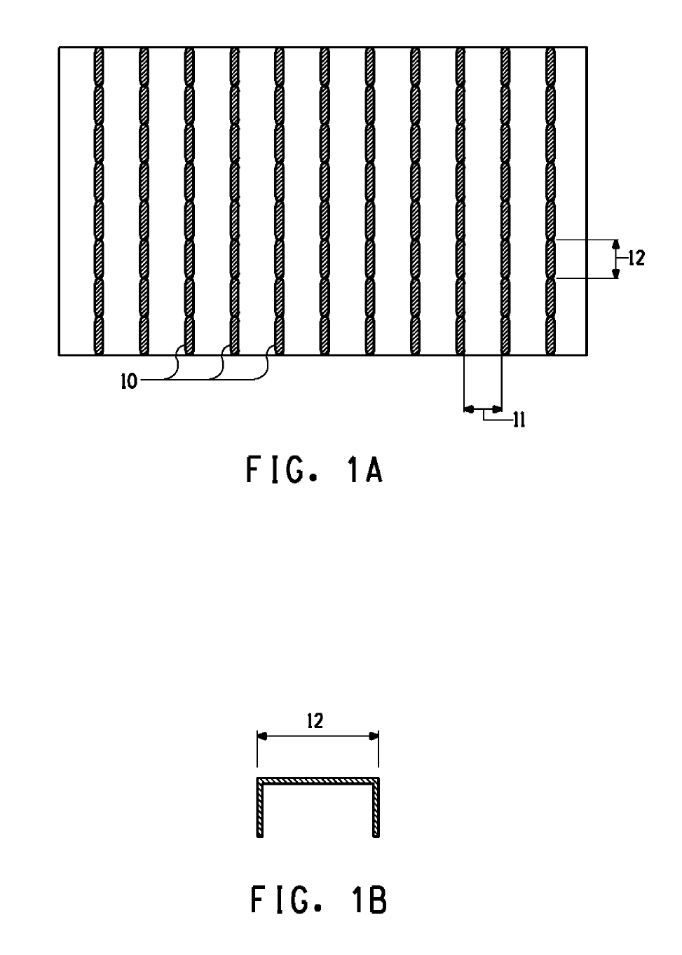

FIG. 1A shows features of a first section namely connector lines 10, connector row spacing 11, connector length 12 and unconnected area 13.

The requirements of the yarn in the fabrics of the first section of the fabric assembly have been set forth above.

Further requirements of the first section are (1) that the fabrics comprising the first section are connected to one another (2) the fabrics are compacted, (3) the fabrics are secured together by connectors having a mechanical strength (force to break in tension) not greater than 65 N and (4) the connectors are concentrated along a series of parallel connector lines as viewed from the fabric on both outer surfaces of the connected sub-assembly, wherein connector lines do not intersect and are spaced from 1.8 mm to 51 mm apart defining regions between the connector lines where the fabric layers remain unconnected.

Requirements (1), (3) and (4) as they pertain to soft body armor are discussed in conjunction with one another.

It is necessary that the fabrics of the first section be physically attached to one another. The attachment of the fabric layers is by connectors having a mechanical strength not greater than 65 N. Preferably the mechanical strength will not be greater than 40N and more preferably 35N. The lower limit for a mechanical strength is not critical but as a practical matter will not be less than 1 N

The force to break in tension of the connector is the multiplier of the ultimate tensile stress of the connector material, or materials, and the cross sectional area of the connector. Thus the dimensions of the connector can be tailored to achieve the desired force to break for a particular material. For chemical connectors the desired dimension is the area of adhesion between two adjacent fabric layers.

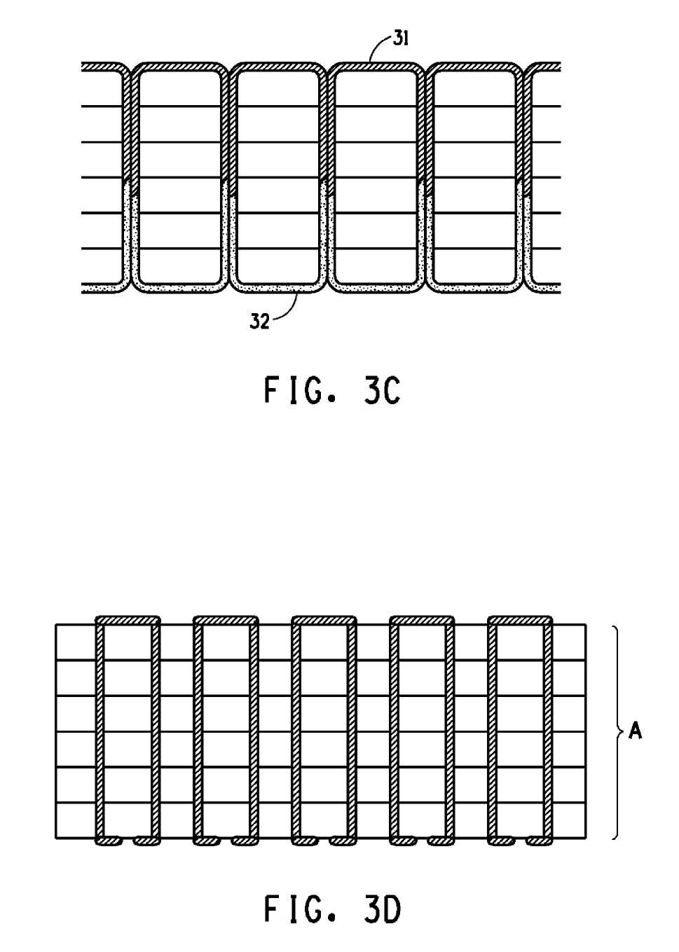

A preferred connector is through the use of thread for stitching, i.e. the separate fabric layers of the first section are stitched together. The thread may be a continuous filament yarn or a staple fiber. One common means of generating the connected sub-assemblies using a single yarn or fiber to generate the rows of stitch connection is through the use of a chain stitch as shown in FIG. 3A. A chain stitch is sometimes referred to as a loop stitch. It is also possible to generate the rows of stitch-connections using a lock stitch as in FIG. 3C, where two threads are looped together to create the stitch—one thread being fed from the top side 31 and the other being fed from the bottom side 32. When a loop stitching technique is being used to sew connector threads, then at least one of the threads must be of a material having a force to break no greater than 65N. If a plied yarn is used as a connector thread, then the combined force to break of the individual threads comprising the yarn must be no greater than 65N. A plied yarn is a yarn formed by twisting together two or more singles yarns.

Suitable thread materials include aramid, cotton, nylon, polyester or elastomeric polyurethane (Lycra®). A connector yarn that shrinks when heated is an alternative means to compact fabric layers.

However it is understood that connectors other than stitching thread or yarn may be employed. These connectors can be mechanical such as by stapling or by chemical means.

Mechanical connectors can be in many forms not only by thread but also by clips, pins, needles or staples and made of polymeric, metal, ceramic or other inorganic material. For pins, clips, needles or staples suitable materials include carbon, glass, ceramic, metal or polymer. FIG. 3D shows a plurality of fabric layers forming a first section that are compacted and held together by staples.

An example of a chemical connector is an adhesive. It is preferable that the adhesive has a modulus no greater than 1379 MPa. The adhesive may be thermoset or thermoplastic preferably curing between 20° C. to 180° C. and more preferably between 20° C. to 120° C. The adhesive may be in the form of a liquid, paste, powder or film. Suitable materials include epoxy, phenolic, urethane, polyester, vinyl ester, polyimide or maleimide. The adhesive connectors may take the form of continuous or broken lines, dots, ovals, diamonds and other shapes.

As set forth above, a connector is required to have a force to break in tension not greater than 65 N. In the case of a mechanical connector the force to break can be determined by testing the connector prior to use. However for a chemical connector, typically it is necessary to determine the mechanical strength in actual use with layers of fabric.

Connector pitch length is (1) for stitches, the distance that the needle advances along a connector line on the surface of the fabric in making one stitch, (2) for clips and staples, the length of the clip or staple as shown at 12 in FIG. 1B and (3) for pins, the diameter of the pin head. This is further detailed in FIGS. 1A to 1B.

Connector row spacing is the distance between adjacent parallel connector lines.

The function of the connector is to enhance the momentum transfer capability of the armor without impacting the mechanical properties of the high tenacity filaments in the fabric. Another requirement is not to over-constrain the axial movement of the filaments in the fabric.

To enhance the momentum transfer, the connectors need to be able to compact the fabric layers in the region where the connector lies on the fabric surface. The connectors also define continuous unconnected regions on the surface and within each of the connected fabrics of the first section of the fabric assembly. The continuous unconnected regions can vary in width from about 1.8 mm to 50 mm, as defined by the row spacing of the connectors. The number and length dimension of the defined unconnected regions in the connected first section of the fabric assembly will be determined by the overall size of the fabric assembly. Since a preferred use of the assembly is as soft body armor to be worn by a person an example of a minimum number of unconnected regions defined by the connector rows on a surface of a fabric assembly will be at least about 50.

The connector may be of any suitable length. Preferably the length is from 1.0 to 15.24 mm and more preferably from 1.5 to 14.22 mm. For adhesive dots, ovals and the like, the length is the maximum dimension of the adhesive dot or oval. It is preferred that the width of regions bounded by the connector rows, or equivalently, the connector row spacing, be less than about 25 mm more preferably less than about 13 mm. For practical reasons, connector row spacing below about 1.8 mm are less desirable due to the risk of yarn damage from the connector insertion process.

Techniques for inserting connectors are well known and include sewing, for thread, and pressure guns, ultrasonics and the like for pins, needles and staples. All these techniques are well known in the textile art.

When connectors are of the sewn type, the type of stitches employed is not critical and may vary widely provided that the required relationships for pitch length and row spacing are followed. Stitching and sewing methods such as hand stitching, multi-thread chain stitching, over edge stitching, flat seam stitching, single thread lock stitching, lock stitching, chain stitching, zig-zag stitching and the like constitute the preferred securing means for use in this invention.

Preferably the orientation of the connector rows relative to the warp and weft yarns of the fabrics can be parallel to the warp yarn direction or parallel to the fill (weft) yarn direction. For the purpose of manufacturing, it is preferred to orient the connector rows parallel to the warp direction of the fabric. The warp direction is also known as the machine direction. Alternatively, the connector rows can be positioned across the connected sub-assembly at some angle other than 0 degrees or 90 degrees relative to the warp or fill direction. It is preferable that the connector lines are positioned in a direction such that they form an angle of from five to eighty five degrees with both the warp and weft yarns of the fabric. More preferably this angle should be from twenty to seventy degrees.

Preferably the fabrics of the first section are compacted and have compaction of at least 2% as set forth in Test Method A. This test defines a procedure wherein the thickness of a fabric is first measured after manufacture and without further handling to decrease the fabric thickness. The thickness of a fabric is then measured after compaction for use in the first section of the fabric assembly. The compaction expressed on a % basis is the amount of decrease of fabric thickness based on the original fabric thickness.

The compacted fabrics for the first section of the fabric assembly will have a compaction of at least 2%, preferably at least 5% and more preferably at least 7%. For purposes of illustration the compaction will not be greater than 20% with a narrower maximum of 15%.

### Second Section of the Fabric Assembly

The requirements of the yarn in the fabrics of the second section of the fabric assembly have been set forth above. The fibers of the second section may be different from those of the first section.

The second section comprises fabrics that are not connected with rows of connectors spaced apart from 1.8 mm to 50 mm and (2) fabrics having a compaction less than 2.0% as set forth in test method A. These essentially non-compacted fabrics are also known in the art as loose plies.

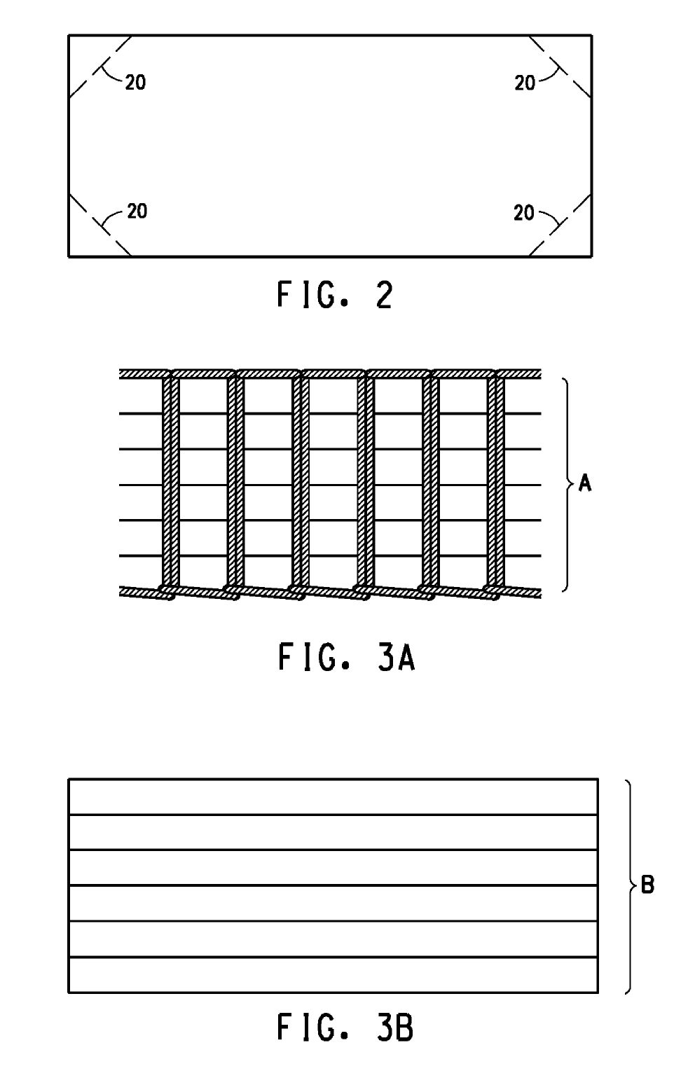

Although it is a preferred feature of the second section is that the fabric layers are not connected to one another and not compacted, it is understood that in manufacture of the overall fabric assembly it may be advisable to keep the fabric layers of the second section aligned without slipping. Therefore, these fabric layers may be held together only to the extent needed to prevent slipping but insufficient to force the layers to compact one another. An example of this is corner stitching as depicted at 20 in FIG. 2. Accordingly the second section preferably has only minimal connection between and among (if more than two) fabrics. However in normal handling and in manufacture a minimum compaction can occur. Preferably the maximum compaction as set forth in Test Method A is not greater than 0.5%, preferably 0.2% and more preferably 0%.

A second section may also encompass fabric layers that are connected by connector threads wherein the connector threads have a force to break of greater than 65N.

### Construction of Fabrics

It is understood that a wide variety of construction techniques may be used for the fabrics of the first and second sections of the fabric assembly. Illustratively the fabrics may be woven, may be unidirectional with or without binder, may be multiaxial with layers of yarn in different orientation or may be three dimensional. The fabrics may be woven multilayer fabrics, such as taught in US Patent Application Publication No. 2011/0240168A1 having warp and/or fill yarns in one layer offset so as to overlap the respective warp or fill yarns in the underlying woven layer. The fabrics used in the first or second sections can be quasi-unidirectional as described in U.S. Pat. Nos. 6,861,378; 7,820,565 and 8,017,532. Each of these fabric styles is well known in the art. It is further understood that different combinations of fabrics both in construction and composition can be employed in the first section and in the second section of the fabric assembly.

Fabrics of different finish states can be used in either or both the first and second sections of the fabric assembly. The fabric finishes of the fabrics of the first and second sections may be the same or different. Woven fabric finish states include greige finish, or loom state. In the greige state, the fabric is often generated with yarns coated with a spin finish lubricant. Fabrics can also be supplied that are substantially free of the spin finish lubricant through rinsing the fabrics with water, water and detergents, or organic solvents to remove the a desired amount of the spin finish. These fabrics are often referred to as scoured fabrics. Additionally, other coatings or finishes can be applied to either the greige or scoured fabrics. These finishes include hydrophobic or oleophobic treatments that can be sprayed onto, or applied through a fabric immersion process. Additives to provide water repellency may also be incorporated into the fabrics of the first and/or second sections.

### Body Armor Article

The body armor article comprises at least two fabric layer sections (sub-assemblies). The body armor article can be generated using exclusively two or more sub-assemblies of first sections. Alternatively, the body armor article can be comprised of at least one first section and at least one second section. Each section (sub-assembly) can have from two to thirty woven fabric layers stacked together. The fabric layers in the different sub-assemblies can be the same or different. The final assembly is then fitted into a vest pack or body armor article.

The total number of fabric layers from all of the sub-assemblies comprising the final assembly, when stacked together, should preferably have an areal density no greater than 5.0 kg/m² and preferably no greater than 4.68 kg/m².

Depending on the ballistic vest design, the number of fabric layers requiring connectors will vary. The location of layers having connectors and those not having connectors can vary within the assembly e.g. . 4A, 4B, 5, 6A and 6B. In these figures, a fabric layer identified with an “A” has connectors and those identified by a “B” has no connectors. Combinations of sub-assemblies other than those described in the drawings are also useful.

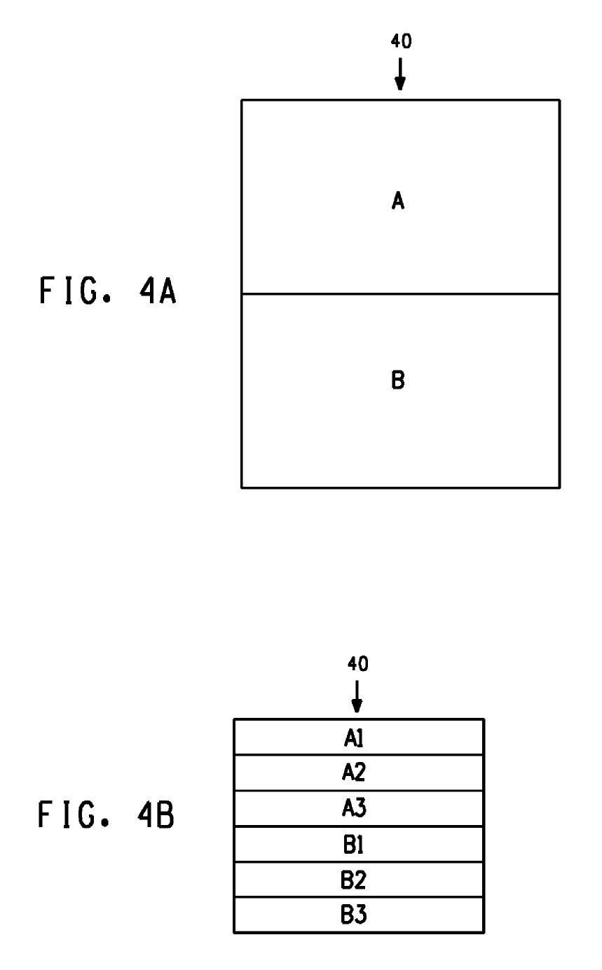

In a first embodiment as shown in FIG. 4A, a sub-assembly “A” comprising fabric layers having connectors is facing the strike direction 40 while a sub-assembly “B” comprising fabric layers without connectors is facing the non-strike direction.

In a second embodiment, a plurality of sub-assemblies each comprising a first section of fabric layers having connectors is facing the strike direction while a plurality of sub-assemblies each comprising second sections of fabric layers without connectors is facing the non-strike direction. This is exemplified by FIG. 4B which shows three sub-assemblies of first sections of fabric layers with connectors, A1, A2 and A3, facing the projectile 40 and three sub-assemblies of second sections of fabric layers without connectors, B1, B2 and B3, facing the non-strike direction.

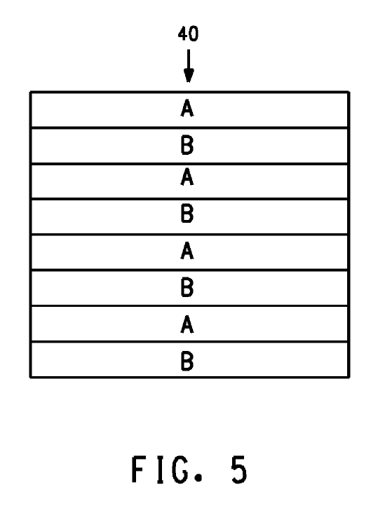

A third embodiment, as in FIG. 5, covers an arrangement of alternating sub-assemblies of fabric layers having connectors “A” and fabric layers without connectors “B”.

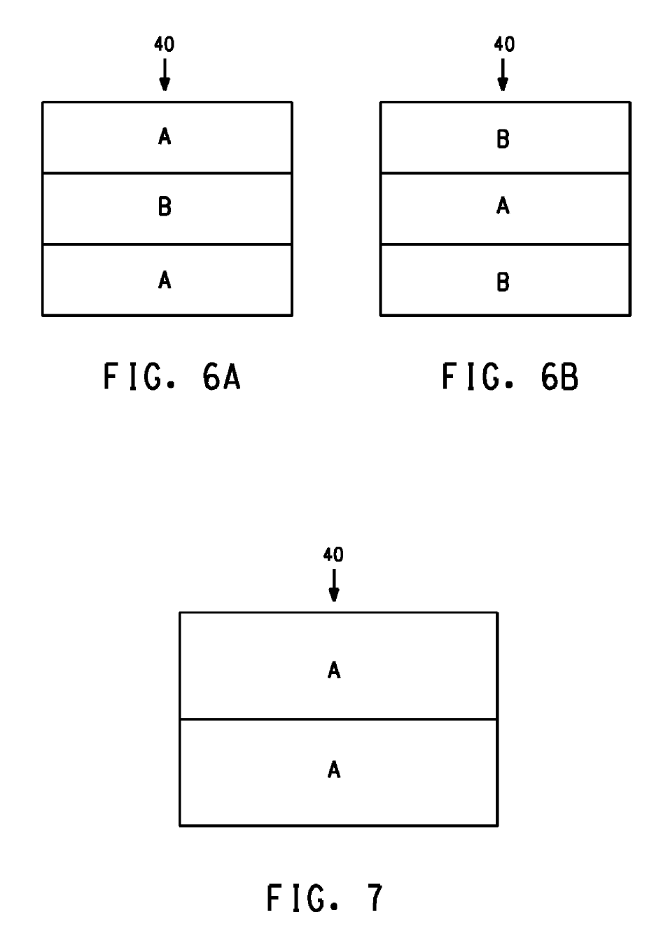

In a fourth embodiment, two sub-assemblies each comprising fabric layers having connectors form the two outer layers of the final assembly with a sub-assembly comprising fabric layers without connectors forming the core of the assembly. This is demonstrated in FIG. 6A.

In a fifth embodiment, two sub-assemblies each comprising fabric layers without connectors form the two outer layers of the final assembly with a sub-assembly comprising fabric layers having connectors forming the core of the assembly. This is demonstrated in FIG. 6B.

In a sixth embodiment, two or more sub-assemblies comprising first sections is demonstrated in FIG. 7.

The fabric layers of the sections without connectors are normally held together to maintain a certain level of coherence. These layers can, for example, be attached by stitches or adhesive or melt bonding at the edges and/or across the corners of the fabric. An example of such stitching is shown in FIG. 2. These stitches in the fabric layers do not compact the layers in the same way as do the connectors and have no influence on anti-ballistic performance. Any suitable thread may be used for sewing at the edges and corners. Aramid thread is particularly suitable for edge and corner stitching. Edge or corner stitching is an optional process for the fabric layers having connectors, the benefit being that it may aid the final assembly process. Another common method to provide coherence to the fabric layers of the second assembly is to quilt stitch across the fabric assembly with the rows of stitches being spaced more than 51 mm apart.

Preferably, the ballistic resistant fabric final assembly has a V50 of at least 465 m/sec when tested against a 9 mm projectile and/or V50 of at least 579 m/sec when tested against a 17 grain projectile and the fabric layers, when stacked together, have a stack areal density not exceeding 4.68 kg/m². V50 is a statistical measure that identifies the average velocity at which a bullet or a fragment penetrates the armor equipment in 50% of the shots, versus non penetration of the other 50%. The parameter measured is V50 at zero degrees where the degree angle refers to the obliquity of the projectile to the target.

### Method of Assembly

A process for making a fabric assembly for a soft body armor article comprises the steps of (1) forming a at least one first section comprising a plurality of fabric layers joined by connectors having a force to break of no greater than 65N, where the connectors are concentrated along a series of parallel connector lines as viewed from the fabric on both outer surfaces of the connected sub-assembly, wherein connector lines do not intersect and are spaced from 1.8 mm to 51 mm apart defining regions between the connector lines where the fabric layers remain unconnected, and (2) optionally forming at least one second section comprising a plurality of fabric layers having no connectors and stitching these layers along the edges and/or across the corners (3) combining a plurality of first sections and, optionally, a plurality of second sections in the desired sequence such that the total weight of all fabric layers is less than 5.0 kg/m²and more preferably less than 4.68 kg/m²and (4) placing the final fabric assembly in a pouch or vest pack.

### Test Methods

Temperature: All temperatures were measured in degrees Celsius (° C.).

Linear Density: The linear density of a yarn or fiber is determined by weighing a known length of the yarn or fiber based on the procedures described in ASTM D1907-97 and D885-98. Decitex or “dtex” is defined as the weight, in grams, of 10,000 meters of the yarn or fiber. Denier (d) is 9/10 times the decitex (dtex).

Tensile Properties: The fibers to be tested were conditioned and then tensile tested based on the procedures described in ASTM D885-98. Tenacity (breaking tenacity), modulus of elasticity, force to break and elongation to break are determined by breaking test fibers on an Instron universal test machine.

Areal Density: The areal density of the fabric layer was determined by measuring the weight of each single layer of selected size, e.g., 10 cm×10 cm. The areal density of a composite structure was determined by the sum of the areal densities of the individual layers.

Ballistic Penetration Performance: Ballistic tests of the multi-layer panels were conducted in accordance with standard procedures such as those described in procurement document FQ/PD 07-05B (Body Armor, Multiple Threat/Interceptor Improved Outer Tactical Vest) and MIL STD 662F (V50 Ballistic Test for Armor). An individual target was tested against a Roma Plastilina clay witness with the 9 mm bullet threat to generate the V50 value presented for each of the example constructions. For some of the example constructions, individual targets were tested using the 17 grain fragment simulating projectile (FSP) threat, with targets fixed about the perimeter in a clamped frame, to determine the 17 grain FSP V50 for the construction. All panel tests for both threats were performed using a 16 shot pattern (4 shots across, 4 shots down, 3″ spacing between shots and/or edges of the panel). The reported V50 values are the result of five complete penetration-partial penetration pairs determined after all 16 shots were completed.

### EXAMPLES

The example constructions described herein are comprised of sub-assemblies of first (connected) sections and/or second (unconnected) sections of anti-ballistic fabric plies. Descriptions of all the anti-ballistic fabrics used to generate the examples are provided in Table 1. A description of the consolidated sub-assemblies is provided in Table 2

Examples prepared according to the process or processes of the current invention are indicated by numerical values. Control or Comparative examples are indicated by letters. Data and test results relating to the Comparative and Inventive Examples are shown in Table 3

### Description of Fabric Layers

Layers of the following high tenacity fiber fabrics used to fabricate sub-assemblies with connectors or incorporated as unconnected ply sub-assemblies in the construction of the inventive and comparative examples are provided below and in Table 1.

Fabric layer “F3” was a plain weave woven fabric of 600 denier (667 dtex) poly(p-phenylene terephthalamide) (or PA) yarn available form E. I. DuPont de Nemours and Company under the trade name of Kevlar® para-aramid brand KM2 Plus yarn and was woven at 11.1×11.1 ends per centimeter (28×28 ends per inch) in both the warp and fill (weft). The fabric was generated by JPS Composite Materials of Anderson, S.C., and had a basis weight of 148 g/m² (4.37 oz/yd²).

Fabric layer “F4” was a twill weave woven fabric of 600 denier (667 dtex) poly(p-phenylene terephthalamide) (or PA) yarn available form E. I. DuPont de Nemours and Company under the trade name of Kevlar® para-aramid brand KM2 Plus yarn and was woven at 11.1×11.1 ends per centimeter (28×28 ends per inch) in both the warp and fill (weft). The fabric was generated by JPS Composite Materials of Anderson, S.C., and had a basis weight of 148 g/m² (4.37 oz/yd²).

Fabric layer “F5” was a plain weave woven fabric of 600 denier (667 dtex) poly(p-phenylene terephthalamide) (or PA) yarn available form E. I. DuPont de Nemours and Company under the trade name of Kevlar® para-aramid brand KM2 Plus yarn and was woven at 9.5×9.5 ends per centimeter (24×24 ends per inch) in both the warp and fill (weft). The fabric was generated by JPS Composite Materials of Anderson, S.C., and had a basis weight of 131 g/m² (3.86 oz/yd²).

Fabric layer “F6” was a 4 harness satin weave woven fabric of 600 denier (667 dtex) poly(p-phenylene terephthalamide) (or PA) yarn available form E. I. DuPont de Nemours and Company under the trade name of Kevlar® para-aramid brand KM2 Plus yarn and was woven at 9.5×9.5 ends per centimeter (24×24 ends per inch) in both the warp and fill (weft). The fabric was generated by JPS Composite Materials of Anderson, S.C., and had a basis weight of 127 g/m² (3.76 oz/yd²).

Fabric layer “F7” was a plain weave woven fabric of 850 denier (944 dtex) poly(p-phenylene terephthalamide) (or PA) yarn available form E. I. DuPont de Nemours and Company under the trade name of Kevlar® para-aramid brand KM2 Plus yarn and was woven at 7.9×7.9 ends per centimeter (20×20 ends per inch) in both the warp and fill (weft). The fabric was generated by Barrday, Inc. of Cambridge, ON Canada, and had a basis weight of 150 g/m² (4.44 oz/yd²).

### Description of Connected Sub-Assemblies

The fabric ply arrangement and connector stitch properties of connected and compacted sub-assemblies are described in Table 2. The order of fabric plies listed in Table 2 and in the descriptions below designates the order the plies are arranged in the connected sub-assemblies from front to back. When incorporated into the ballistic test panel arrangements described in the example cases, all connected sub-assemblies are oriented with the front facing the impact direction. Lock stitch connector stitching was achieved using a Juki sewing machine, model LU 563. Chain stitch connector stitching was achieved using a RACOP 2-V stitchbonding loom manufactured by LIBA Maschinenfabrik GmbH of Oberklingensporn, Germany.

### Ballistic Vest Pack Constructions

### Comparative Example M

In this example, one second section sub-assembly (designated C2 in Table 2) containing fifteen layers of fabric F3 having length and width dimensions of 38 cm×38 cm (15″×15″) were held together by connector threads sewn through, and orthogonal to, the plane of the fifteen layers so as to form a second section. The sewn through series of connectors were concentrated along a series of parallel connector lines as viewed from either outer surface. The parallel connector lines were generated with continuous thread using a lock stitch. The connector material was 351 dtex (316 denier) Kevlar® thread from United Thread Mills having a force to break of 69.8N. The connector pitch length was 3.18 mm, and the connector row spacing was 6.35 mm. The second section sub-assembly with connectors was then combined with a different second section sub-assembly comprising sixteen loose unconnected layers of fabric F3 cut to 38 mm×38 mm (15″×15″) by corner stitching into an article with an areal density of 4.64 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The test article was oriented such that the sub-assembly with the connectors was facing the projectile. The result of the ballistic test performed on the article (16 shot pattern, 5 pair V50) is presented in Table 3

### Comparative Example N

In this example, one sub-assembly (designated C4 in Table 2) containing fifteen layers of fabric F3 having length and width dimensions of 38 cm×38 cm (15″×15″) were held together by connector threads sewn through, and orthogonal to, the plane of the fifteen layers so as to form a second section sub-assembly. The sewn through series of connectors were concentrated along a series of parallel connector lines as viewed from either outer surface. The parallel connector lines were generated with continuous thread using a lock stitch. The connector material was 351 dtex (316 denier) Kevlar® thread from United Thread Mills having a force to break of 69.8 N. The connector pitch length was 3.18 mm, and the connector row spacing was 12.7 mm. The second section sub-assembly with connectors was then combined with a different second section sub-assembly comprising sixteen loose unconnected layers of fabric F3 cut to 38 mm×38 mm (15″×15″) by corner stitching into an article with an areal density of 4.66 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The test article was oriented such that the sub-assembly with the connectors was facing the projectile. The result of the ballistic test performed on the article (16 shot pattern, 5 pair V50) is presented in Table 3.

### Comparative Example O

In this example, a second section comprising thirty one unattached layers of fabric F3 having length and width dimensions of 38 cm×38 cm (15″×15″) were held together by stitching located at the four corners of the layers (corner stitched outside of the shot testing pattern) into a test article with an areal density of 4.59 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The result of the ballistic test performed on the article comprised only of loose fabric plies (16 shot pattern, 5 pair V50) is presented in Table 3.

### Comparative Example P

In this example, two identical second section test articles were fabricated from (in order from front to back) one layer of fabric F5, thirteen layers of fabric F4, and seventeen layers of fabric F3, having length and width dimensions of 38 cm×38 cm (15″×15″). These loose unconnected plies were held together by stitching located at the four corners of the layers (corner stitched outside of the shot testing pattern) into a test article with an areal density of 4.66 kg/m². The corner stitching thread was 800 dtex (720 denier) Kevlar® under the trade name B-92 from Imperial Threads Inc. Ballistic testing of one of the two articles was conducted using 9 mm 124 grain FMJ bullets against the final article supported on a Roma Plastilina number 1 clay backing medium. The ballistic impact testing of the second article was conducted using 17 grain FSPs. The result of the ballistic tests performed on these identical articles comprised only of loose fabric plies (16 shot pattern, 5 pair V50) is presented in Table 3.

### Comparative Example Q

In this example, two loose ply second section test articles were each fabricated from (in order from front to back) one layer of fabric F5, thirteen layers of fabric F4, three layers of fabric F3, one layer of fabric F5, thirteen layers of fabric F4, having length and width dimensions of 38 cm×38 cm (15″×15″). These loose unconnected plies were held together by stitching located at the four corners of the layers (corner stitched outside of the shot testing pattern) into a test article with an areal density of 4.72 kg/m². The corner stitching thread was 800 dtex (720 denier) Kevlar® under the trade name B-92 from Imperial Threads Inc. Ballistic testing of one of the two articles was conducted using 9 mm 124 grain FMJ bullets against the final article supported on a Roma Plastilina number 1 clay backing medium. The ballistic impact testing of the second article was conducted using 17 grain FSPs. The result of the ballistic tests performed on these identical articles comprised only of loose fabric plies (16 shot pattern, 5 pair V50) is presented in Table 3.

### Comparative Example R

In this example, two identical second section test articles were fabricated from (in order from front to back) one layer of fabric F5, thirteen layers of fabric F4, one layer of fabric F5, thirteen layers of fabric F4, having length and width dimensions of 38 cm×38 cm (15″×15″). These loose unconnected plies were held together by stitching located at the four corners of the layers (corner stitched outside of the shot testing pattern) into a test article with an areal density of 4.72 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The result of the ballistic test performed on this article comprised only of loose fabric plies (16 shot pattern, 5 pair V50) is presented in Table 3.

### Example 13

In this example, one first section sub-assembly (designated C1 in Table 2) containing fifteen layers of fabric F3 having length and width dimensions of 38 cm×38 cm (15″×15″) were held together by connector threads sewn through, and orthogonal to, the plane of the fifteen layers so as to form a first section. The sewn through series of connectors were concentrated along a series of parallel connector lines as viewed from either outer surface. The parallel connector lines were generated with continuous threads using a lock stitch. The connector material was 351 dtex (316 denier) Kevlar® thread from United Thread Mills having a force to break of 29N. The connector pitch length was 3.18 mm, and the connector row spacing was 6.35 mm. The first section sub-assembly with connectors was then combined with a second section comprising sixteen loose unconnected layers of fabric F3 cut to 38 mm×38 mm (15″×15″) by corner stitching into an article with an areal density of 4.64 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The test article was oriented such that the first section sub-assembly with the connectors was facing the projectile. The result of the ballistic test performed on the article (16 shot pattern, 5 pair V50) is presented in Table 3.

This inventive Example 13 construction incorporating one C1 first section of fabric layers comprising connector yarns having a force to break of 29N demonstrates, for a 9 mm projectile, a V50 improvement of 22 m/s (4.6%) over the control Example O which comprised unconnected loose plies of F3 fabric. This example also demonstrates an 8 m/s (1.6%) improvement over Example M, incorporating a C2 sub-assembly arrangement fabricated with connecting yarns having a force to break of 69.8N.

### Example 14

In this example, one first section sub-assembly (designated C3 in Table 4) containing fifteen layers of fabric F3 having length and width dimensions of 38 cm×38 cm (15″×15″) were held together by connector threads sewn through, and orthogonal to, the plane of the fifteen layers so as to form a first section. The sewn through series of connectors were concentrated along a series of parallel connector lines as viewed from either outer surface. The parallel connector lines were generated with continuous thread using a lock stitch. The connector material was 351 dtex (316 denier) Kevlar® thread from United Thread Mills having a force to break of 29N. The connector pitch length was 3.18 mm, and the connector row spacing was 12.7 mm. The first section sub-assembly with connectors was then combined with a second section comprising sixteen loose unconnected layers of fabric F3 cut to 38 mm×38 mm (15″×15″) by corner stitching into an article with an areal density of 4.62 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The test article was oriented such that the sub-assembly with the connectors was facing the projectile. The result of the ballistic test performed on the article (16 shot pattern, 5 pair V50) is presented in Table 3.

This inventive Example 13 construction incorporating one C3 first section of fabric layers comprising connector yarns having a force to break of 29N demonstrates, for a 9 mm projectile, a V50 improvement of 19 m/s (4.0%) over the control Example O which comprised of loose unconnected plies of F3 fabric. This example also demonstrates a 6 m/s (1.2%) improvement over Example M, incorporating a C4 sub-assembly arrangement fabricated with connecting yarns having a force to break of 69.8N.

### Example 15

In this example, two identical test articles were fabricated from (in order from front to back) one first section sub-assembly (designated C5 in Table 2) containing one layer of fabric F5, thirteen layers of fabric F4, width dimensions of 38 cm×38 cm (15″×15″), held together by connector threads sewn through, and orthogonal to, the plane of the fifteen layers so as to form a first section. The sewn through series of connectors were concentrated along a series of parallel connector lines as viewed from either outer surface. The parallel connector lines were generated with continuous thread using a chain stitch. The connector material was 169 dtex (1.52 denier) texturized polyester fiber having a force to break of 6.8 N. The connector pitch length was 2.54 mm, and the connector row spacing was 7.26 mm. The first section sub-assembly with connectors was then combined with a second section comprising seventeen loose unconnected layers of fabric F3 cut to 38 mm×38 mm (15″×15″). The connected sub-assembly and the loose plies were held together by stitching located at the four corners of the layers (corner stitched outside of the shot testing pattern) to generate each test article having an areal density of 4.66 kg/m². The corner stitching thread was 800 dtex (720 denier) Kevlar® under the trade name B-92 from Imperial Threads Inc. Ballistic testing of one of the two articles was conducted using 9 mm 124 grain FMJ bullets against the final article supported on a Roma Plastilina number 1 clay backing medium. The ballistic impact testing of the second article was conducted using 17 grain FSPs. The result of the ballistic tests performed on these identical articles comprised only of loose fabric plies (16 shot pattern, 5 pair V50) is presented in Table 3.

This inventive Example 15 construction incorporating one C5 first section of fabric layers comprising connector yarns having a force to break of 6.89N demonstrates, for a 9 mm projectile, a V50 improvement of 13 m/s (2.7%), and a 17 grain FSP V50 improvement of 23 m/s (4%) over the control panel Example P having an identical fabric arrangement but without any ply layers being connected by connector threads.

### Example 16

In this example, two identical test articles were fabricated from (in order from front to back) one first section sub-assembly (designated C5 in Table 2) containing one layer of fabric F5, thirteen layers of fabric F4, width dimensions of 38 cm×38 cm (15″×15″), held together by connector threads sewn through, and orthogonal to, the plane of the fourteen layers. The sewn through series of connectors were concentrated along a series of parallel connector lines as viewed from either outer surface. The parallel connector lines were generated with continuous thread using a chain stitch. The connector material was 169 dtex (1.52 denier) texturized polyester fiber having a force to break of 6.8 N. The connector pitch length was 2.54 mm, and the connector row spacing was 7.26 mm. The first section sub-assembly C5 described above was combined with a second section comprising three fabric F3 loose unconnected plies and a second first section C5 sub-assembly, also cut to 38 mm×38 mm (15″×15″). This arrangement was held together by stitching located at the four corners of the layers (corner stitched outside of the shot testing pattern) to generate each test article having an areal density of 4.72 kg/m². The corner stitching thread was 800 dtex (720 denier) Kevlar® under the trade name B-92 from Imperial Threads Inc. Ballistic testing of one of the two articles was conducted using 9 mm 124 grain FMJ bullets against the final article supported on a Roma Plastilina number 1 clay backing medium. The ballistic impact testing of the second article was conducted using 17 grain FSPs. The result of the ballistic tests performed on these identical articles comprised only of loose fabric plies (16 shot pattern, 5 pair V50) is presented in Table 3.

This inventive example 16 construction incorporating two first sections having fabric layers connected by threads having a force to break of 6.8N demonstrates, for a 9 mm projectile, a V50 improvement of 40 m/s (8.6%) over the control Example Q having an identical fabric arrangement but without any fabric layers being connected by connector threads.

### Example 17

In this example, two first section sub-assemblies (designated C5 in Table 4) each containing one fabric layer F5 and thirteen fabric layers F4 having length and width dimensions of 38 cm×38 cm (15″×15″) being held together by connector threads sewn through, and orthogonal to, the plane of the fourteen layers, were assembled. The sewn through series of connectors were concentrated along a series of parallel connector lines as viewed from either outer surface. The parallel connector lines were generated with continuous thread using a chain stitch. The connector material was 169 dtex (1.52 denier) texturized polyester fiber having a force to break of 6.8 N. The connector pitch length was 2.54 mm, and the connector row spacing was 7.26 mm. The two first section sub-assemblies were then combined and corner stitched into an article with an areal density of 4.27 kg/m². The corner stitching thread was 800 dtex (720 denier) Kevlar® under the trade name B-92 from Imperial Threads Inc. Ballistic tests were conducted using 9 mm 124 grain FMJ bullets against the final article supported on a Roma Plastilina number 1 clay backing medium. The test article was oriented such that the sub-assembly with the connectors was facing the projectile. The result of the ballistic test performed on the article (16 shot pattern, 5 pair V50) is presented in Table 3.

This inventive Example 17 construction incorporating two first sections demonstrates, for a 9 mm projectile, a V50 improvement of 26 m/s (5.6%) over the control Example R having an identical fabric arrangement but without any fabric layers being connected by connector threads.

### Example 18

In this example, two identical test articles were fabricated from (in order from front to back) one first section sub-assembly (designated C6 in Table 2) containing one fabric layer F5 and fourteen fabric layers F6 having length and width dimensions of 38 cm×38 cm (15″×15″) and held together by connector threads sewn through, and orthogonal to, the plane of the fifteen layers. The sewn through series of connectors were concentrated along a series of parallel connector lines as viewed from either outer surface. The parallel connector lines were generated with continuous thread using a chain stitch. The connector material was 169 dtex (152 denier) texturized polyester fiber having a force to break of 6.8 N. The connector pitch length was 1.81 mm, and the connector row spacing was 3.63 mm. The first section sub-assembly was then combined with a second section comprising eighteen loose unconnected layers of fabric F3 cut to 38 mm×38 mm (15″×15″) by corner stitching into an article with an areal density of 4.69 kg/m². The corner stitching thread was 800 dtex (720 denier) Kevlar® under the trade name B-92 from Imperial Threads Inc. Ballistic testing on one of the panels was conducted using 9 mm 124 grain FMJ bullets against the final article supported on a Roma Plastilina number 1 clay backing medium. The second panel was tested in a frame and clamp assembly against 17 grain FSPs. The test article was oriented such that the sub-assembly with the connectors was facing the projectile. The result of the 9 mm and 17 grain FSP ballistic test performance on the article (16 shot pattern, 5 pair V50) is presented in Table 3.

### Example 19

In this example, two identical test articles were fabricated from (in order from front to back) one first section sub-assembly (designated C6 in Table 2) containing one layer of fabric F5, thirteen layers of fabric F6, width dimensions of 38 cm×38 cm (15″×15″), held together by connector threads sewn through, and orthogonal to, the plane of the fourteen layers. The sewn through series of connectors were concentrated along a series of parallel connector lines as viewed from either outer surface. The parallel connector lines were generated with continuous thread using a chain stitch. The connector material was 169 dtex (1.52 denier) texturized polyester fiber having a force to break of 6.8 N. The connector pitch length was 1.81 mm, and the connector row spacing was 3.63 mm. The first section sub-assembly C6 described above was then combined with a second section of five fabric F3 loose unconnected plies and a second C6 first section sub-assembly, also cut to 38 mm×38 mm (15″×15″). This final assembly was held together by stitching located at the four corners of the layers (corner stitched outside of the shot testing pattern) to generate each test article having an areal density of 4.70 kg/m². The corner stitching thread was 800 dtex (720 denier) Kevlar® under the trade name B-92 from Imperial Threads Inc. Ballistic testing on one of the panels was conducted using 9 mm 124 grain FMJ bullets against the final article supported on a Roma Plastilina number 1 clay backing medium. The second panel was tested in a frame and clamp assembly against 17 grain FSPs. The test article was oriented such that the sub-assembly with the connectors was facing the projectile. The result of the 9 mm and 17 grain FSP ballistic test performance on the article (16 shot pattern, 5 pair V50) is presented in Table 3.

### Example 20

In this example, two identical test panels were generated using two different first section sub-assemblies (designated C7 and C8 in Table 2). First section sub-assembly C7 was made with sixteen layers of F4 fabric, the stitching used was a lock stitch with a pitch length of 3.18 mm and a row spacing of 6.35 mm. The connector material was 351 dtex (316 denier) Kevlar® thread from United Thread Mills having a force to break of 29N. The connector stitching direction for C7 was oriented in the bias direction (rotated 45 degrees relative to the warp direction). First section sub-assembly C8 was produced sixteen layers of F7 fabric having length and width dimensions of 38 cm×38 cm (15″×15″) and held together by connectors sewn through, and orthogonal to, the plane of the sixteen layers. The sewn through series of connectors were concentrated along a series of parallel connector lines as viewed from either outer surface. The parallel connector lines were generated with continuous thread using a lock stitch. The connector material was 351 dtex (316 denier) Kevlar® thread from United Thread Mills having a force to break of 29 N. The connector pitch length was 3.18 mm, and the connector row spacing was 6.35 mm. The two first sections were then combined with first section C7 facing the projectile. The corner stitching thread was 800 dtex (720 denier) Kevlar® under the trade name B-92 from Imperial Threads Inc. Ballistic testing on one of the panels was conducted using 9 mm 124 grain FMJ bullets against the final article supported on a Roma Plastilina number 1 clay backing medium. The second panel was tested in a frame and clamp assembly against 17 grain FSPs. The test article was oriented such that the C7 connected sub-assembly was facing the projectile. The result of the 9 mm and 17 grain FSP ballistic test performance on the article (16 shot pattern, 5 pair V50) is presented in Table 3.

### Example 21

In this example, two identical test panels were generated, each with five first section C9 sub-assemblies cut to 38 mm×38 mm (15″×15″). Each first section was made with one layer of F5 fabric and six layers of F6 fabric. The sewn through series of connectors were concentrated along a series of parallel connector lines as viewed from either outer surface. The parallel connector lines were generated with continuous connector thread using a chain stitch. The connector material was 169 dtex (152 denier) texturized polyester fiber having a force to break of 6.8 N. The connector pitch length was 1.81 mm, and the connector row spacing was 3.63 mm. The areal density of the test panel was 4.66 kg/m². Ballistic testing on one of the panels was conducted using 9 mm 124 grain FMJ bullets against the final article supported on a Roma Plastilina number 1 clay backing medium. The second panel was tested in a frame and clamp assembly against 17 grain FSPs. The result of the 9 mm and 17 grain FSP ballistic test performance on the article (16 shot pattern, 5 pair V50) is presented in Table 3.

TABLE 1

| Fabric | |
|---|---|
| Reference | Construction |
| F3 | 600 d Kevlar ® KM2 Plus 28 × 28 plain weave |
| F4 | 600 d Kevlar ® KM2 Plus 28 × 28 twill weave |
| F5 | 600 d Kevlar ® KM2 Plus 24 × 24 plain weave |
| F6 | 600 d Kevlar ® KM2 Plus 24 × 24, 4-harness satin |
| F7 | 850 d Kevlar ® KM2 Plus20 × 20 plain weave |

TABLE 2

| | | | Connector | | | Pitch | Row | Basis |
|---|---|---|---|---|---|---|---|---|
| Section | Section | Connector | Force to | Connector | Connector | Length | Spacing | weight |
| Reference | Build | Material | Break (N) | Method | Orientation | (mm) | (mm) | (kg/m²) |
| C1 | 15xF3 | 351 dtex | 29 | lock stitch | linear row, | 3.18 | 6.35 | 2.27 |
| | | Kevlar ® | | (continuous) | parallel to | | | |
| | | spun yarn | | | fabric | | | |
| | | | | | warp | | | |
| C2 | 15xF3 | 961 dtex | 69.8 | lock stitch | linear row, | 3.18 | 6.35 | 2.3 |
| | | Kevlar ® | | (continuous) | parallel to | | | |
| | | spun yarn | | | fabric | | | |
| | | | | | warp | | | |
| C3 | 15xF3 | 351 dtex | 29 | lock stitch | linear row, | 3.18 | 12.7 | 2.25 |
| | | Kevlar ® | | (continuous) | parallel to | | | |
| | | spun yarn | | | fabric | | | |
| | | | | | warp | | | |
| C4 | 15xF3 | 961 dtex | 69.8 | lock stitch | linear row, | 3.18 | 12.7 | 2.28 |
| | | Kevlar ® | | (continuous) | parallel to | | | |
| | | spun yarn | | | fabric | | | |
| | | | | | warp | | | |
| C5 | 1xF5, | 169 dtex | 6.8 | chain stitch | linear row, | 2.54 | 7.26 | 2.13 |
| | 13F4 | texturized | | (continuous) | parallel to | | | |
| | | polyester | | | fabric | | | |
| | | | | | warp | | | |
| C6 | 1xF5, | 169 dtex | 6.8 | chain stitch | linear row, | 1.81 | 3.63 | 2.01 |
| | 14F6 | texturized | | (continuous) | parallel to | | | |
| | | polyester | | | fabric | | | |
| | | | | | warp | | | |
| C7 | 16F4 | 351 dtex | 29 | lock stitch | parallel to | 3.18 | 6.35 | 2.27 |
| | | Kevlar ® | | (continuous) | fabric | | | |
| | | spun yarn | | | warp | | | |
| C8 | 16F7 | 351 dtex | 29 | lock stitch | 45 deg. | 3.18 | 6.35 | 2.43 |
| | | Kevlar ® | | (continuous) | Diagonal | | | |
| | | spun yarn | | | to fabric | | | |
| | | | | | warp | | | |
| C9 | 1F5, | 85 dtex | 6.8 | chain stitch | linear row, | 1.81 | 3.63 | 0.93 |
| | 6xF6 | texturized | | | parallel to | | | |
| | | polyester | | | fabric | | | |
| | | | | | warp | | | |

TABLE 3

| | | Areal | 9mm | 17 gr |
|---|---|---|---|---|
| | | Density | V50 | V50 |
| Example | Article Construction | (kg/m²) | (m/s) | (m/s) |
| 13 | C1, 16 × F3 | 4.64 | 503 | — |
| M | C2, 16 × F3 | 4.67 | 495 | — |
| 14 | C3, 16 × F3 | 4.62 | 500 | — |
| N | C4, 16 × F3 | 4.66 | 494 | — |
| O | 31 × F3 | 4.59 | 481 | — |
| 15 | C5, 17 × F3 | 4.66 | 496 | 599 |
| 16 | C5, 3 × F3, C5 | 4.72 | 504 | 614 |
| 17 | 2 × C5 | 4.27 | 491 | — |
| P | 1 × F5, 13F4, 17 × F3 | 4.66 | 483 | 576 |
| Q | 1 × F5, 13 × F4, 3 × F3, | 4.72 | 464 | 611 |
| | 1 × F5, 13 × F4 | | | |
| R | 1 × F5, 13 × F4, | 4.27 | 465 | — |
| | 1 × F5, 13 × F4 | | | |
| 18 | C6, 18 × F3 | 4.69 | 507 | 608 |
| 19 | C6, 5 × F4, C6 | 4.70 | 489 | 607 |
| 20 | C7, C8 | 4.71 | 486 | 596 |
| 21 | 5 × C9 | 4.66 | 486 | 592 |

What is claimed is:

1. A fabric assembly suitable for resisting a ballistic object in soft body armor comprising:
(a) at least one first section comprising a plurality of connected and compacted fabric layers made from continuous yarn having a tenacity of at least 7.3 grams per dtex and a modulus of at least 100 grams per dtex, wherein
(i) the connected and compacted fabric layers are secured together by connectors having a force to break in tension not greater than 65 N,
(ii) the connectors are concentrated along a series of parallel connector lines as viewed from the fabric on both outer surfaces of the first section, and
(iii) the connector lines do not intersect and are spaced from 1.8 mm to 51 mm apart defining regions between the connector lines where the fabric layers remain unconnected, and
(b) at least one second section comprising a plurality of fabric layers made from continuous yarn having a tenacity of at least 7.3 grams per dtex and a modulus of at least 100 grams per dtex wherein the fabrics of the second section are not secured together by parallel connector lines that are spaced from 1.8 mm to 51 mm apart defining regions between the connector lines where the fabric layers remain unconnected, the connectors having a force to break in tension not greater than 65 N.

2. The fabric assembly of claim 1 wherein the fabrics of the second section are connected only with sufficient mechanical strength to prevent slippage of the layers relative to one another.

3. The fabric assembly of claim 1 wherein the total number of fabric layers of the first and second sections, when stacked together, have an areal density less than 5.0 kg/m².

4. A fabric assembly of claim 1 wherein the connector is in the form of a thread comprising filaments of cotton, polyester, p-aramid, elastomeric polyurethane and mixtures thereof.

5. The fabric of claim 1, wherein the continuous yarns are made of filaments made from a polymer selected from the group consisting of polyamides, polyolefins, polyazoles, and mixtures thereof.

6. The fabric of claim 1, wherein the connector lines are spaced in a range from 3.6 mm to 51 mm.

7. The fabric of claim 6, wherein the connector lines are spaced in a range from 6 mm to 51 mm.

8. A process for making a fabric assembly for a soft body armor article comprising the steps of:
(a) forming at least one first section comprising a plurality of connected and compacted fabric layers made from continuous yarn having a tenacity of at least 7.3 grams per dtex and a modulus of at least 100 grams per dtex, wherein
(i) the connected and compacted fabric layers are secured together by connectors having a force to break in tension not greater than 65 N,
(ii) the connectors are concentrated along a series of parallel connector lines as viewed from the fabric on both outer surfaces of the first section, and
(iii) the connector lines do not intersect and are spaced from 1.8 mm to 51 mm apart defining regions between the connector lines where the fabric layers remain unconnected, and
(b) forming at least one second section comprising a plurality of fabric layers made from continuous yarn having a tenacity of at least 7.3 grams per dtex and a modulus of at least 100 grams per dtex wherein the fabrics of the second section are not secured together by parallel connector lines that are spaced from 1.8 mm to 51 mm apart defining regions between the connector lines where the fabric layers remain unconnected, the the connectors having a force to break in tension not greater than 65 N,
(c) securing the plurality of fabric layers of the second section at the corners and around the edges so as to provide a cohesive bundle and
(e) combining at least one first section with at least one second section into a fabric assembly.
